(19) United States
(12) Patent Application Publication
(10) Pub. No.: US 2025/0322421 A1
(43) Pub. Date: Oct. 16, 2025

(54) INFORMATION PROCESSING APPARATUS, INFORMATION PROCESSING METHOD, AND RECORDING MEDIUM

(71) Applicant: PLAID, INC., Tokyo (JP)

(72) Inventors: Yuki MAKINO, Tokyo (JP); Atsushi KOBAYASHI, Tokyo (JP); Yui YASUNAGA, Tokyo (JP)

(21) Appl. No.: 18/868,120

(22) PCT Filed: May 8, 2023
(86) PCT No.: PCT/JP2023/017270

§ 371 Date: Nov. 21, 2024

(30) Foreign Application Priority Data
May 23, 2022 (JP) 2022-083522

(51) Int. Cl. G06Q 30/0207; G06Q 30/0201; G06Q 30/0601

(52) U.S. Cl. CPC G06Q 30/0207; G06Q 30/0201; G06Q 30/0631; G06Q 30/0641

(57) ABSTRACT

An information processing apparatus includes: a correspondence storage unit in which one or more pieces of correspondence information each indicating correspondence between an intention identifier based on one or more pieces of operation information and action information for specifying an action that is to be performed on a terminal apparatus of a user are stored; a receiving unit that receives one or two or more pieces of operation information; a determining unit that determines an intention identifier corresponding to the one or more pieces of operation information received by the receiving unit; an information acquiring unit that refers to the correspondence storage unit, thereby acquiring action information corresponding to the intention identifier determined by the determining unit; and an action unit that performs an action specified with the action information acquired by the information acquiring unit, on a terminal apparatus corresponding to a user identifier.

### TECHNICAL FIELD

The present invention relates to an information processing apparatus and the like for estimating an intention of a user based on an operation performed by the user on a webpage, and performing an action corresponding to the intention.

### BACKGROUND ART

Conventionally, there has been a technique that can grasp the status of visitors to a website in real time (see Patent Document 1). Such a technique involves a server apparatus including: a user information storage unit in which two or more pieces of user information are stored, the user information being information on a user and being information having one or more attribute values; an operation information receiving unit that receives, from a user terminal of a user who is visiting a website, operation information on an operation performed by the user on the website; an attribute value acquiring unit that acquires one or more attribute values of the user who is visiting the website, using the operation information, and an attribute value output unit that outputs the one or more attribute values acquired by the attribute value acquiring unit.

### CITATION LIST

### Patent Document

Patent Document 1: JP 2018-190008A

### SUMMARY OF INVENTION

### Technical Problem

However, it is not possible for conventional techniques to estimate an intention of a user based on an operation performed by the user on a webpage, and perform an appropriate action corresponding to the intention.

### Solution to Problem

A first aspect of the present invention is directed to an information processing apparatus including: a correspondence storage unit in which one or more pieces of correspondence information each indicating correspondence between an intention identifier based on one or more pieces of operation information and action information for specifying an action that is to be performed on a terminal apparatus of a user are stored; a receiving unit that receives one or two or more pieces of operation information associated with a user identifier; a determining unit that determines an intention identifier corresponding to the one or more pieces of operation information received by the receiving unit; an information acquiring unit that refers to the correspondence storage unit, thereby acquiring action information corresponding to the intention identifier determined by the determining unit; and an action unit that performs an action specified with the action information acquired by the information acquiring unit, on a terminal apparatus corresponding to the user identifier.

With this configuration, it is possible to estimate an intention of a user based on an operation performed by the user on a webpage, and perform an appropriate action corresponding to the intention.

Furthermore, a second aspect of the present invention is directed to the information processing apparatus according to the first aspect, wherein the correspondence information is information indicating correspondence between the intention identifier, an intensity condition regarding intensity information indicating intensity of an intention of a user, and the action information, and the information acquiring unit acquires intensity information using the one or more pieces of operation information received by the receiving unit, and refers to the correspondence storage unit, thereby acquiring the action information corresponding to the intention identifier determined by the determining unit and an intensity condition that the intensity information matches.

With this configuration, it is possible to estimate an intention of a user and intensity of the intention based on an operation performed by the user on a webpage, and perform an appropriate action corresponding to the intention and the intensity.

Furthermore, a third aspect of the present invention is directed to the information processing apparatus according to the first aspect, wherein the correspondence information is information indicating correspondence between the intention identifier, an abstraction level condition regarding abstraction level information indicating an abstraction level of an intention of a user, and the action information, and the information acquiring unit acquires abstraction level information using the one or more pieces of operation information received by the receiving unit, and refers to the correspondence storage unit, thereby acquiring the action information corresponding to the intention identifier determined by the determining unit and an abstraction level condition that the abstraction level information matches.

With this configuration, it is possible to estimate an intention of a user and an abstraction level of the intention based on an operation performed by the user on a webpage, and perform an appropriate action corresponding to the intention and the abstraction level.

Furthermore, a fourth aspect of the present invention is directed to the information processing apparatus according to the first aspect, wherein the correspondence information is information indicating correspondence between the intention identifier, an attribute value condition regarding one or more user attribute values, and the action information, and the information acquiring unit acquires a user attribute value, and refers to the correspondence storage unit, thereby acquiring the action information corresponding to the intention identifier determined by the determining unit and a user attribute value condition that the user attribute value matches.

With this configuration, it is possible to estimate an intention of a user based on an operation performed by the user on a webpage, and perform an appropriate action corresponding to the intention and a user attribute value.

Furthermore, a fifth aspect of the present invention is directed to the information processing apparatus according to any one of the first to fourth aspects, wherein the information acquiring unit further acquires unique information in the one or more pieces of operation information, from the one or more pieces of operation information, and the action unit performs an action using the action information and the unique information.

With this configuration, it is possible to estimate an intention of a user based on an operation performed by the user on a webpage, and perform an appropriate action corresponding to the intention, using unique information acquired from the operation information.

Furthermore, a sixth aspect of the present invention is directed to the information processing apparatus according to any one of the first to fourth aspects, further including: an intention storage unit in which two or more intention identifiers are stored in association with a user identifier; and an intention accumulating unit that accumulates the intention identifier determined by the determining unit, in the intention storage unit, in association with a user identifier, wherein the information acquiring unit acquires the action information corresponding to two or more intention identifiers associated with one user identifier, the two or more intention identifiers having been accumulated by the intention accumulating unit.

With this configuration, it is possible to estimate multiple intentions of a user based on an operation performed by the user on a webpage, and perform an appropriate action corresponding to the multiple intentions.

Furthermore, a seventh aspect of the present invention is directed to the information processing apparatus according to any one of the first to fourth aspects, wherein the intention identifier is associated with one or more operation conditions based on two or more pieces of operation information, and the determining unit detects an operation condition that matches the one or more pieces of operation information, and determines the intention identifier corresponding to the operation condition.

With this configuration, it is possible to estimate an intention of a user based on a pattern of an operation performed by the user on a webpage, and perform an appropriate action corresponding to the intention.

Furthermore, an eighth aspect of the present invention is directed to the information processing apparatus according to any one of the first to fourth aspects, further including: a model storage unit in which a model acquired through learning processing of machine learning using two or more pieces of training data each having one or more pieces of operation information and an intention identifier is stored, wherein the determining unit performs prediction processing of machine learning using the one or more pieces of operation information and the model, and determines the intention identifier.

With this configuration, it is possible to estimate an intention of a user based on an operation performed by the user on a webpage in accordance with an machine learning algorithm, and perform an appropriate action corresponding to the intention.

### Advantageous Effects of Invention

With the information processing apparatus according to the present invention, it is possible to estimate an intention of a user based on an operation performed by the user on a webpage, and perform an appropriate action corresponding to the intention.

### BRIEF DESCRIPTION OF DRAWINGS

FIG. 1 is a conceptual diagram of an information system A in Embodiment 1.

FIG. 2 is a block diagram of the information system A in the embodiment.

FIG. 3 is a flowchart illustrating an operation example of an information processing apparatus 1 in the embodiment.

FIG. 4 is a flowchart illustrating an example of intention determining processing in the embodiment.

FIG. 5 is a flowchart illustrating an example of action processing in the embodiment.

FIG. 6 is a flowchart illustrating an example of pre-processing in the embodiment.

FIG. 7 is a diagram showing a user information management table in the embodiment.

FIG. 8 is a diagram showing a first correspondence information management table in the embodiment.

FIG. 9 is a diagram showing a second correspondence information management table in the embodiment.

FIG. 10 is a diagram showing an intensity management table in the embodiment.

FIG. 11 is a diagram showing an abstraction level management table in the embodiment.

FIG. 12 is a diagram showing an operation information management table in the embodiment.

FIG. 13 is a diagram showing a user intention management table in the embodiment.

FIG. 14 is a block diagram of an information system B in Embodiment 2.

FIG. 15 is a flowchart illustrating an operation example of intention determination in the embodiment.

FIG. 16 is a schematic view of a computer system in the foregoing embodiments.

FIG. 17 is a block diagram of the computer system in the foregoing embodiments.

### DESCRIPTION OF EMBODIMENT

Hereinafter, an embodiment of an information processing apparatus and the like will be described with reference to the drawings. It should be noted that constituent elements denoted by the same reference numerals in the embodiments perform similar operations, and thus a description thereof may not be repeated.

### Embodiment 1

In this embodiment, an information system including an information processing apparatus that receives one or more pieces of operation information, acquires an intention identifier from the one or more pieces of operation information, and performs, on a user, an action corresponding to the intention identifier will be described. The action is, for example, an action using unique information acquired from the operation information.

Furthermore, in this embodiment, an information system including an information processing apparatus that further acquires intensity information of the intention, and performs, on a user, an action corresponding to the intention identifier and the intensity information will be described.

Furthermore, in this embodiment, an information system including an information processing apparatus that further acquires abstraction level information of the intention, and performs, on a user, an action corresponding to the intention identifier and the abstraction level information will be described.

Furthermore, in this embodiment, an information system including an information processing apparatus that determines an action using two or more intention identifiers will be described.

Moreover, in this embodiment, an information system including an information processing apparatus that performs an action corresponding to an operation condition will be described.

In this specification, the state in which information X is associated with information Y means that the information Y can be acquired from the information X or the information X can be acquired from the information Y, and there is no limitation on the method for associating the information. The information X and the information Y may be linked to each other or in the same buffer. The information X may be contained in the information Y, or the information Y may be contained in the information X, for example.

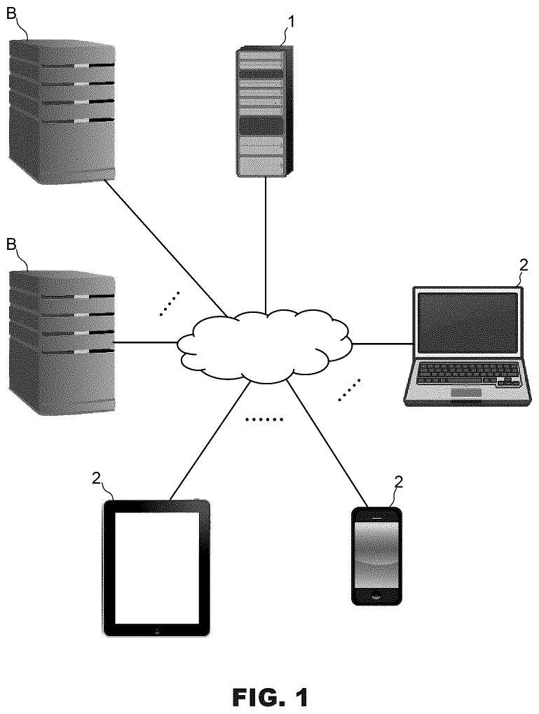

FIG. 1 is a conceptual diagram of an information system A in this embodiment. The information system A includes an information processing apparatus 1 and one or two or more terminal apparatuses 2.

The information processing apparatus 1 is an apparatus that performs an action on the terminal apparatuses 2 based on operation information. The information processing apparatus 1 is typically a so-called server. The information processing apparatus 1 is, for example, a cloud server, an ASP server, or the like, but there is no limitation on the type thereof. The information processing apparatus 1 may also serve as a web server.

The terminal apparatuses 2 are terminals that are used by users. The terminal apparatuses 2 are terminals that each access one or two or more web servers B, and output a webpage. The terminal apparatuses 2 are terminals that accept an operation on a webpage. The terminal apparatuses 2 are, for example, terminals that send operation information based on an accepted operation, to the information processing apparatus 1. The terminal apparatuses 2 are, for example, so-called personal computers, tablet devices, smartphones, or the like, but there is no limitation on the type thereof.

The information processing apparatus 1 and the one or more terminal apparatuses 2 can communicate with each other via a network such as the Internet. It is also possible that the one or more terminal apparatuses 2 can communicate with one or more web servers (not shown) as well via a network such as the Internet.

Furthermore, the one or more terminal apparatuses 2 can communicate with the web servers B via a network such as the Internet. It is preferable that the information processing apparatus 1 can communicate with the web servers B via a network such as the Internet.

The web servers B are servers in which a webpage is stored and that send the webpage to the terminal apparatuses 2 in response to a request from the terminal apparatuses 2. The web servers B are, for example, servers for running a website. The web servers B may send operation information according to an operation accepted from the terminal apparatuses 2, to the information processing apparatus 1. The website is, for example, a so-called e-commerce site, but may also be a site that is not an e-commerce site and can be used to provide information, or the like, but there is no limitation on the type thereof. The web servers B are cloud servers, ASP servers, or the like, but there is no limitation on the type thereof.

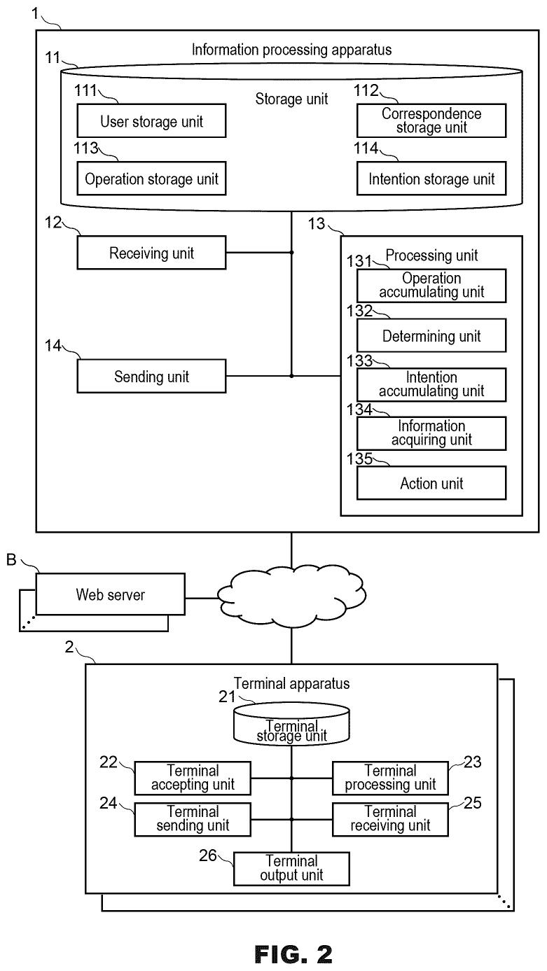

FIG. 2 is a block diagram of the information system A in this embodiment. The information processing apparatus 1 constituting the information system A includes a storage unit 11, a receiving unit 12, a processing unit 13, and a sending unit 14.

The storage unit 11 includes a user storage unit 111, a correspondence storage unit 112, an operation storage unit 113, and an intention storage unit 114. The processing unit 13 includes an operation accumulating unit 131, a determining unit 132, an intention accumulating unit 133, an information acquiring unit 134, and an action unit 135.

The terminal apparatuses 2 each include a terminal storage unit 21, a terminal accepting unit 22, a terminal processing unit 23, a terminal sending unit 24, a terminal receiving unit 25, and a terminal output unit 26.

Various types of information are stored in the storage unit 11 constituting the information processing apparatus 1. The various types of information are, for example, later-described user information, later-described correspondence information, later-described operation information, or later-described intention identifiers.

One or two or more pieces of user information are stored in the user storage unit 111. The user information is information on a user. The user information has a user identifier and one or more user attribute values.

The user identifier is information for identifying a user. The user identifier is, for example, a user ID, an e-mail address, a telephone number, or a user name.

The user attribute values are attribute values of a user identified with a user identifier. The one or more user attribute values may be static attribute values or dynamic attribute values. The static attribute values are typically attribute values that do not change, but may be considered as being attribute values that do not change from time to time. The static attribute values are, for example, a name, an age, an address, a telephone number, a user-specific image, a credit card number, an e-mail address, a terminal apparatus identifier, a password, or the like. The terminal apparatus identifier is information for identifying a terminal apparatus 2 that is used by a user and is, for example, a cookie ID, a session identifier, an IP address, a MAC address, or the like. The dynamic attribute values are attribute values that can dynamically change according to user operations or the like. The dynamic attribute values are, for example, a real-time dynamic attribute value or a historical-information-using dynamic attribute value. The real-time dynamic attribute value is an attribute value that changes in real-time from time to time. The real-time dynamic attribute value is, for example, the time a currently-visiting-user spent on a webpage (hereinafter referred to as a “page” as appropriate), the number of webpages viewed during the current visit, or the like. The historical-information-using dynamic attribute value is a dynamic attribute value acquired using a history of operation information during previous visits. The historical-information-using dynamic attribute value is, for example, the number of purchases, a purchase price, a purchase total, an average time spent, the average number of PVs, the number of visits, or a score calculated using other user attribute values (e.g., the number of purchases or the purchase total).

One or two or more pieces of correspondence information are stored in the correspondence storage unit 112. The correspondence information in the correspondence storage unit 112 is typically associated with a web server B. The state of being associated with a web server B may be a state of being associated with a website or a webpage. That is to say, it is preferable that the method for determining an intention and the action that is to be performed vary depending on a website.

The correspondence information is information for determining an action corresponding to a determined intention. The correspondence information is information indicating correspondence between the intention identifier and the action information. The correspondence information has, for example, an operation condition and action information. The operation condition is associated with an intention identifier. The operation condition is a condition regarding one or two or more pieces of operation information. The operation condition may be a later-described operation pattern. The operation condition may contain a condition regarding the number of specific operations. The operation condition may contain a condition regarding the time spent on a specific webpage. The operation condition may contain a condition regarding the order of two or more specific operations. The operation condition may be a condition regarding a combination of two or more specific operations.

The correspondence information may be information indicating correspondence between the intention identifier, the action information, and the intensity information. The information indicating correspondence with the intensity information may be, for example, information indicating correspondence with an intensity condition. The intensity condition is a condition regarding intensity information. The intensity condition is, for example, “intensity information>=3”. The intensity information is information indicating intensity of an intention of a user. The intensity information is, for example, any natural number from “1” to “5”, or “A”, “B” or “C”.

The correspondence information may be information indicating correspondence between the intention identifier, the action information, and the abstraction level information. The information indicating correspondence with the abstraction level information may be, for example, information indicating correspondence with an abstraction level condition. The abstraction level condition is a condition regarding abstraction level information. The abstraction level condition is, for example, “abstraction level information>=4”. The abstraction level information is information indicating an abstraction level of an intention of a user. The abstraction level information is, for example, any natural number from “1” to “5”, or “A”, “B” or “C”.

The correspondence information may be information indicating correspondence between the intention identifier, the action information, and the user attribute value. The information indicating correspondence with the user attribute value may be, for example, information indicating correspondence with a user attribute value condition. The user attribute value condition is a condition regarding one or two or more user attribute values. The user attribute value condition preferably includes a condition regarding one or two or more dynamic attribute values. The user attribute value condition preferably includes a condition regarding one or two or more real-time dynamic attribute values. The user attribute value condition preferably includes a condition regarding one or two or more historical-information-using dynamic attribute values. The user attribute value condition is, for example, “purchase total>=10,000 yen”, “number of purchases>=5”, or “time spent>=3 minutes”.

The correspondence information may be information indicating correspondence between the intention identifier, the intention pattern, and the action information. The intention pattern is, for example, a condition regarding two or more intention identifiers. The intention pattern is, for example, a condition regarding one or more intention identifiers and one or more pieces of operation information. If the intention pattern includes a condition regarding two or more intention identifiers, the intention pattern may contain a condition regarding the order of the two or more intention identifiers or a condition regarding a combination of the two or more intention identifiers. The condition regarding the order of the two or more intention identifiers is a condition regarding the chronological order in which the two or more intention identifiers were determined. The order of the two or more intention identifiers is determined based on the time information associated with each of the two or more intention identifiers.

Each intention identifier is information for specifying an intention based on one or more pieces of operation information. The intention identifier is typically information for specifying an intention based on two or more pieces of operation information. The intention identifier is, for example, information for specifying an intention based on a history of two or more pieces of operation information (two or more pieces of operation information based on operations at different times). The intention identifier is, for example, an ID for identifying an intention (intention ID) or a character string that describes an intention. The intention identifier is preferably associated with one or more operation conditions based on two or more pieces of operation information.

The operation information is information on an operation performed by a user on a webpage. The operation information is, for example, information indicating that a page was accessed, information indicating that a page was viewed, information indicating that a button in a page was clicked, information indicating that an anchor was given, information indicating that an operation to jump to another page was performed, information entered in a field, information indicating that an item was added to favorites, information indicating that an item name was entered and searched for, or the like. The operation information may be information on results of an operation. The information on results of an operation may be, for example, the relative coordinates of the center of a window on a webpage as a result of scrolling. The information on results of an operation is, for example, an item identifier or an item attribute value (e.g., a price, an item image, a size, the number in stock, availability, or a coordination example) of an item displayed in a window as a result of scrolling. The information on results of an operation is, for example, an item identifier of an item purchased, an item identifier of an item placed in the cart, or an item identifier of an item added to favorites. The item identifier is, for example, an item ID or an item name.

The operation information is, for example, “rightButtonON” (indicating that a right mouse button was clicked), “drug object A” (indicating that an object A was dragged), “<purchased item ID>123<quantity>3” (indicating that three items identified with 123 were purchased), “jump http://www.xxx.co.jp” (indicating that a webpage specified with URL “http://www.xxx.co.jp” was accessed), or the like. The operation information in this case is, for example, information on a primitive operation, but it is preferably information with which the meaning or implication of the operation can be determined. That is to say, there is no limitation on the data structure, the information granularity, and the like of the operation information. The operation information is typically information for specifying an operation performed by a user, but may include information on processing performed by the information processing apparatus 1 as a result of an operation by a user. The operation information received by the receiving unit 12 may be different from the operation information stored in the operation storage unit 113. The operation information received by the receiving unit 12 and the operation information accumulated in the operation storage unit 113 may be different from each other, for example, in data structure or the like. For example, the operation information received by the receiving unit 12 may be information on a primitive operation (e.g., “rightButtonON”), and the operation information accumulated in the operation storage unit 113 may be information (e.g., “Page OO is displayed”) with which the meaning or implication of the operation can be determined. In this case, the processing unit 13 configures operation information that is to be stored in the operation storage unit 113, using the received operation information. In this case, for example, the processing unit 13 acquires operation information that is paired with the received primitive operation information, from the storage unit 11.

The operation information is preferably associated with time information, a user identifier, or a page identifier.

The time information specifies the time at which an operation was performed. The time information is, for example, information for specifying a date, a date and time, time, or a period (e.g., a sale period). The time at which an operation was performed may be the time at which operation information was received. That is to say, the time at which an operation was performed does not need to be strictly defined, as long as the time of an operation performed by a user can be generally specified.

The page identifier is information for identifying a webpage on which an operation was performed. The page identifier is, for example, a URL, a URI, or an ID of a webpage. The webpage may also be a website. The webpage in this case may be considered as being synonymous with a website. That is to say, the page identifier may be information for identifying a website.

The operation pattern is a pattern of operations specified with one or two or more pieces of operation information. The operation pattern is, for example, “information indicating that a user visited a webpage two or more times during a sale period”, “information indicating that a user has performed a search using the same item name as a key word N times or more (N is a natural number of 2 or more)”, “information indicating that after (1) accessing the homepage and (2) accessing the favorite-items link, (3) the ‘also recommended’ link was clicked”, “information indicating that (1) the items-not-yet-in-stock page was accessed and (2) a jump operation to another page or a logout operation was performed within a threshold time”, or “information indicating that items whose number is greater than or equal to a first threshold value were added to favorites, and no items were added to the cart for a period of time longer than or equal to a second threshold value in a state in which items whose number is greater than or equal to the first threshold value had been added to favorites”. The operation pattern may be considered as being an example of an operation condition.

The action information is information for specifying an action that is to be performed on a terminal apparatus 2 of a user. The action may be rephrased as processing or an operation. The action information is, for example, a function name, a pointer to a program to jump to, a module name, or a method name. The action information is, for example, “information indicating that a banner that allows access to sale items is sent to the terminal apparatus 2”, “information indicating that an e-mail announcing a sale is sent at the time of a sale”, “information indicating that a chat invitation to the effect that details can be checked with a clerk is sent to the terminal apparatus 2”, “information indicating that (1) processing to acquire item information on a webpage that a user is viewing or item information in favorites and (2) processing to send a banner to the terminal apparatus 2 to access a webpage that contains item information on an item whose item type matches the acquired item information and that is a feature page for recently popular items are successively performed”, “information indicating that information on a registration guide for an e-mail to make a notification regarding the item arrival is sent to the terminal apparatus 2”, or “information indicating that (1) processing to detect that a favorite item is on sale and (2) processing to, after that detection, send an e-mail to the terminal apparatus 2 informing that the favorite item is on sale are successively performed”.

One or more pieces of operation information based on an operation performed by a user are stored in the operation storage unit 113. The operation information in this case is preferably associated with a user identifier, a page identifier, and time information. The page identifier in this case is, for example, information for identifying a page that is being output to a terminal apparatus 2 of a user identified with a user identifier, the page being a page on which an operation is to be performed. The page identifier may be information for identifying a page that the user has accessed in the past. The operation information in the operation storage unit 113 is typically information accumulated by the operation accumulating unit 131, which will be described later, but there is no limitation on the procedure in which the information is accumulated.

An intention identifier for specifying an intention based on an operation performed by a user is stored in the intention storage unit 114. One or two or more intention identifiers are typically stored in the intention storage unit 114 in association with each of one or two or more user identifiers. Each intention identifier in the intention storage unit 114 is an intention identifier determined by the determining unit 132. The intention identifier in the intention storage unit 114 is preferably associated with time information. The time information associated with the intention identifier is information for specifying the time at which a user performed an operation on a page and an intention identifier was determined.

The receiving unit 12 receives one or two or more pieces of operation information associated with a user identifier. The receiving unit 12 typically directly or indirectly receives operation information from the terminal apparatuses 2. Note that the receiving unit 12 may receive operation information from the web servers B. The receiving unit 12 may receive operation information accumulated in other apparatuses from these other apparatuses. The operation information received by the receiving unit 12 is typically associated with time information. The time information associated with the operation information is generally information for specifying the time at which an operation was performed.

The processing unit 13 performs various types of processing. The various types of processing are, for example, processing that is performed by the operation accumulating unit 131, the determining unit 132, the intention accumulating unit 133, the information acquiring unit 134, and the action unit 135.

For example, the processing unit 13 may analyze the operation information in the operation information storage unit 114, thereby acquiring a dynamic attribute value of each user. For example, the processing unit 13 updates a dynamic attribute value of a user based on the received operation information. For example, if the received operation information is an instruction to send a website, the processing unit 13 measures the time spent on the website, which is the time until an instruction to move to another website or an instruction to logout is received, and accumulates the time spent in the user storage unit 111. For example, the processing unit 13 increments the number of visits to the website or webpage of the server apparatus 1 based on received login instructions or received website sending instructions, and accumulates the obtained value in the user storage unit 111. For example, the processing unit 13 increments the number of purchases based on received item purchase instructions, which are instructions to purchase an item, and accumulates the obtained value in the user storage unit 111. For example, the processing unit 13 substitutes, as parameters, one or more of the time spent on a website or webpage, the number of purchases, a purchase price, a purchase total, the number of PVs, an average time spent, and the number of visits for a score calculation formula, thereby calculating a score of each user. The score calculation formula is stored in the storage unit 11. The score calculation formula is information on a formula for calculating a score of a user. For example, the higher the score of a user, the more important the user is considered to be. The score calculation formula is, for example, an increasing function whose parameters are one or more of the time spent on a website or webpage, the number of purchases, a purchase price, a purchase total, the number of PVs, an average time spent, and the number of visits.

The operation accumulating unit 131 accumulates the operation information received by the receiving unit 12, in the operation storage unit 113. For example, the operation accumulating unit 131 accumulates the operation information received by the receiving unit 12, in the operation storage unit 113, in association with one or two or more of a user identifier, a page identifier, and time information.

For example, in the case in which the receiving unit 12 receives operation information, the operation accumulating unit 131 acquires a user identifier that is paired with the operation information. For example, the operation accumulating unit 131 acquires time information indicating the current time from a clock (not shown). For example, the operation accumulating unit 131 acquires a page identifier contained in the operation information. For example, the operation accumulating unit 131 accumulates the operation information received by the receiving unit 12, in the operation storage unit 113, in association with the user identifier, the page identifier, and the time information.

The determining unit 132 determines an intention identifier corresponding to the one or more pieces of operation information received by the receiving unit 12. The determining an intention identifier is determining an intention. The determining an intention identifier may be determining action information.

For example, the determining unit 132 detects an operation condition that matches the one or more pieces of operation information, and determines an intention identifier corresponding to the operation condition. For example, the determining unit 132 detects an operation condition that matches the one or more pieces of operation information corresponding to the user identifier, out of the one or more operation conditions in the correspondence storage unit 112, and determines an intention identifier corresponding to the operation condition.

For example, the determining unit 132 acquires one or more pieces of operation information that are each paired with one user identifier. For example, the determining unit 132 acquires one or more pieces of operation information that are each paired with one user identifier, from the operation storage unit 113. For example, the determining unit 132 acquires the operation information received by the receiving unit 12. Next, for example, the determining unit 132 determines an operation condition that the acquired one or two or more pieces of operation information match, out of the operation conditions stored in the correspondence storage unit 112, and acquires an intention identifier corresponding to the operation condition. The determining unit 132 may acquire action information corresponding to the determined operation condition, instead of acquiring an intention identifier.

Furthermore, for example, the determining unit 132 may acquire intensity information corresponding to the determined operation condition, from the correspondence storage unit 112. For example, the determining unit 132 may acquire abstraction level information corresponding to the determined operation condition, from the correspondence storage unit 112.

There is no limitation on the time when the determining unit 132 determines an intention identifier. The determining unit 132 preferably performs processing for acquiring an intention identifier, each time the receiving unit 12 receives operation information. Note that the determining unit 132 may perform processing for acquiring an intention identifier in the case in which a predetermined time is reached, the case in which an instruction is received from a terminal (not shown) of the administrator of the information processing apparatus 1 or the web servers B, or the like. There may be a case in which even if such processing is performed, the determining unit 132 cannot acquire an intention identifier.

The intention accumulating unit 133 accumulates the intention identifier determined by the determining unit 132, in the intention storage unit 114, in association with a user identifier. The intention accumulating unit 133 may acquire time information, and accumulate the intention identifier in the intention storage unit 114 in association with the time information as well. For example, the intention accumulating unit 133 may acquire time information from a clock (not shown), or may acquire time information received by the receiving unit 12, for example.

The information acquiring unit 134 refers to the correspondence storage unit 112, thereby acquiring action information corresponding to the intention identifier determined by the determining unit 132. The information acquiring unit 134 may acquire action information determined by the determining unit 132.

The information acquiring unit 134 may refer to the correspondence storage unit 112, thereby acquiring action information and intensity information corresponding to the intention identifier determined by the determining unit 132.

The information acquiring unit 134 may refer to the correspondence storage unit 112, thereby acquiring action information and abstraction level information corresponding to the intention identifier determined by the determining unit 132.

The information acquiring unit 134 preferably further acquires unique information in the one or more pieces of operation information, from the one or more pieces of operation information. The unique information is information unique to the corresponding operation information or information unique to a page on which an operation indicated by the corresponding operation information is performed. The unique information is, for example, an item identifier (e.g., an item name), or one or two or more item attribute values (e.g., an item type or an item price).

The information acquiring unit 134 preferably acquires action information corresponding to two or more intention identifiers associated with one user identifier, the intention identifiers being two or more intention identifiers accumulated by the intention accumulating unit 133.

For example, the information acquiring unit 134 acquires intensity information using the one or more pieces of operation information received by the receiving unit 12. For example, the information acquiring unit 134 refers to the correspondence storage unit 112, thereby acquiring the action information corresponding to the intention identifier determined by the determining unit 132 and an intensity condition that the intensity information matches. For example, the information acquiring unit 134 acquires intensity source information from the one or more pieces of operation information. The information acquiring unit 134 acquires intensity information corresponding to the intensity source information. The intensity source information is information from which intensity information is acquired. The intensity source information is, for example, the time spent on a webpage that a user is viewing, the number of times a webpage is viewed, or the number of item names searched for. For example, the information acquiring unit 134 acquires intensity information that is paired with the intensity condition satisfied by the intensity source information. In this case, each of the two or more intensity conditions and the intensity information are managed as a pair. For example, the information acquiring unit 134 acquires greater intensity information in accordance with an increase in the time spent on a webpage. For example, the information acquiring unit 134 acquires greater intensity information in accordance with an increase in the number of times a webpage is viewed. For example, the information acquiring unit 134 acquires smaller intensity information in accordance with an increase in the number of item names searched for. The reason for this is that there is no particular focus on a particular item.

For example, the information acquiring unit 134 acquires abstraction level information, using the one or more pieces of operation information received by the receiving unit 12. For example, the information acquiring unit 134 refers to the correspondence storage unit 112, thereby acquiring the action information corresponding to the intention identifier determined by the determining unit 132 and an abstraction level condition that the abstraction level information matches. For example, the information acquiring unit 134 acquires abstraction level source information from the one or more pieces of operation information. The information acquiring unit 134 acquires abstraction level information corresponding to the abstraction level source information. The abstraction level source information is information from which abstraction level information is acquired. The abstraction level source information is, for example, the time spent on a webpage that a user is viewing, the number of webpages viewed, or the number of item names searched for. For example, the information acquiring unit 134 acquires abstraction level information that is paired with the abstraction level condition satisfied by the abstraction level source information. In this case, each of the two or more abstraction level conditions and the abstraction level information are managed as a pair. For example, the information acquiring unit 134 acquires greater abstraction level information in accordance with a decrease in the time spent on a webpage. For example, the information acquiring unit 134 acquires smaller abstraction level information in accordance with an increase in the number of times a webpage is viewed. For example, the information acquiring unit 134 acquires greater abstraction level information in accordance with an increase in the number of item names searched for.

For example, the information acquiring unit 134 acquires intensity information and abstraction level information, using the one or more pieces of operation information received by the receiving unit 12. For example, the information acquiring unit 134 refers to the correspondence storage unit 112, thereby acquiring the action information corresponding to the intention identifier determined by the determining unit 132, the intensity information, and the abstraction level information.

The action unit 135 performs an action specified with the action information acquired by the information acquiring unit 134, on the terminal apparatus 2 corresponding to the user identifier.

The action unit 135 preferably performs an action according to the action information and the intensity information that are acquired by the information acquiring unit 134.

The action unit 135 preferably performs an action according to the action information and the abstraction level information that are acquired by the information acquiring unit 134.

The action unit 135 preferably performs an action using the action information and the unique information that are acquired by the information acquiring unit 134.

The sending unit 14 sends various types of information. The sending unit 14 typically sends various types of information to the terminal apparatuses 2.

Various types of information are stored in the terminal storage unit 21 constituting each terminal apparatus 2. The various types of information are, for example, a user identifier.

The terminal accepting unit 22 accepts input of instructions, information, and the like. The input of instructions, information, and the like may also be said to be an operation. The instructions, information, and the like are, for example, a page identifier for identifying a page or an access instruction. The access instruction is an instruction to access a page such as a webpage, and has a page identifier. The accepting in this case is a concept that encompasses accepting information input from an input device such as a keyboard, a mouse, or a touch screen, receiving information sent via a wired or wireless communication line, and accepting information read from a recording medium such as an optical disk, a magnetic disk, or a semiconductor memory.

The instructions, information, and the like may be input by any input part such as a touch screen, a keyboard, a mouse, or a menu screen. The terminal accepting unit 22 may be realized by a device driver for an input part such as a touch screen or a keyboard, control software for a menu screen, or the like.

The terminal processing unit 23 performs various types of processing. The various types of processing are, for example, processing for changing the instructions, information, and the like accepted by the terminal accepting unit 22 into instructions, information, and the like with a structure for sending, processing for changing the information received by the terminal receiving unit 25 into information with a structure for output, or the like.

For example, the terminal processing unit 23 configures operation information based on the operation accepted by the terminal accepting unit 22.

For example, the terminal processing unit 23 acquires a page, using the page identifier accepted by the terminal accepting unit 22. For example, the terminal processing unit 23 accesses a web server (not shown) identified with the page identifier accepted by the terminal accepting unit 22, and receives a page.

The terminal sending unit 24 sends the operation information acquired by the terminal processing unit 23, to a web server corresponding to the webpage on which the operation was performed.

The terminal sending unit 24 may send the operation information acquired by the terminal processing unit 23, to the information processing apparatus 1.

The terminal receiving unit 25 receives various types of information. For example, the terminal receiving unit 25 receives various types of information from the information processing apparatus 1. For example, the terminal receiving unit 25 receives a webpage or processing results from a web server.

The terminal output unit 26 outputs the information received by the terminal receiving unit 25. The information received by the terminal receiving unit 25 is, for example, a webpage or various types of information.

The output in this case is typically display on a display screen, but may be considered as being a concept that encompasses projection using a projector, printing by a printer, output of a sound, sending to an external apparatus, accumulation in a recording medium, and delivery of a processing result to another processing apparatus or another program.

The storage unit 11, the user storage unit 111, the correspondence storage unit 112, the operation storage unit 113, the intention storage unit 114, and the terminal storage unit 21 are preferably non-volatile recording media, but may alternately be realized by volatile recording media.

There is no limitation on the procedure in which information is stored in the storage unit 11 and the like. For example, information may be stored in the storage unit 11 and the like via a recording medium, information sent via a communication line or the like may be stored in the storage unit 11 and the like, or information input via an input device may be stored in the storage unit 11 and the like.

The receiving unit 12 and the terminal receiving unit 25 are typically realized by wireless or wired communication parts, but may also be realized by broadcast receiving parts.

The processing unit 13, the operation accumulating unit 131, the determining unit 132, the intention accumulating unit 133, the information acquiring unit 134, the action unit 135, and the terminal processing unit 23 may be typically realized by processors, memories, or the like. Typically, the processing procedure of the processing unit 13 and the like is realized by software, and the software is stored in a recording medium such as a ROM. However, the processing procedure may be realized by hardware (dedicated circuits). The processors are, for example, CPUs, MPUs, GPUs, or the like, but there is no limitation on the type thereof.

The sending unit 14, the action unit 135, and the terminal sending unit 24 are, for example, realized by wireless or wired communication parts, but may also be realized by broadcasting parts.

The terminal accepting unit 22 may be realized by a device driver for an input part such as a touch screen or a keyboard, control software for a menu screen, or the like.

The terminal output unit 26 may be considered to include or to not include an output device such as a display screen or a speaker. The terminal output unit 26 may be realized by driver software for an output device, a combination of driver software for an output device and the output device, or the like.

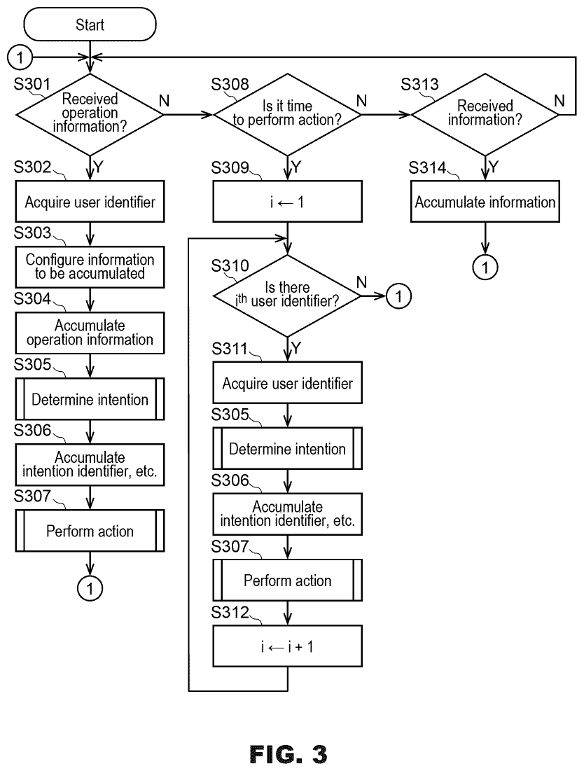

Next, an operation example of the information system A will be described. First, an operation example of the information processing apparatus 1 will be described with reference to the flowchart in FIG. 3.

(Step S301) The receiving unit 12 determines whether or not it has received one or more pieces of operation information associated with a user identifier. If it has received operation information, the procedure advances to step S302, or otherwise the procedure advances to step S308.

(Step S302) The operation accumulating unit 131 acquires a user identifier associated with the operation information received in step S301. This user identifier is an identifier of a user who performed an operation from which the operation information received in step S301 was acquired.

(Step S303) The operation accumulating unit 131 configures information that is to be accumulated, the information containing the operation information received in step S301. The information that is to be accumulated preferably has time information. The operation accumulating unit 131 may acquire time information received in step S301, or may acquire time information from a clock (not shown).

(Step S304) The operation accumulating unit 131 accumulates the information configured in step S303, in the operation storage unit 113, in association with the user identifier acquired in step S302.

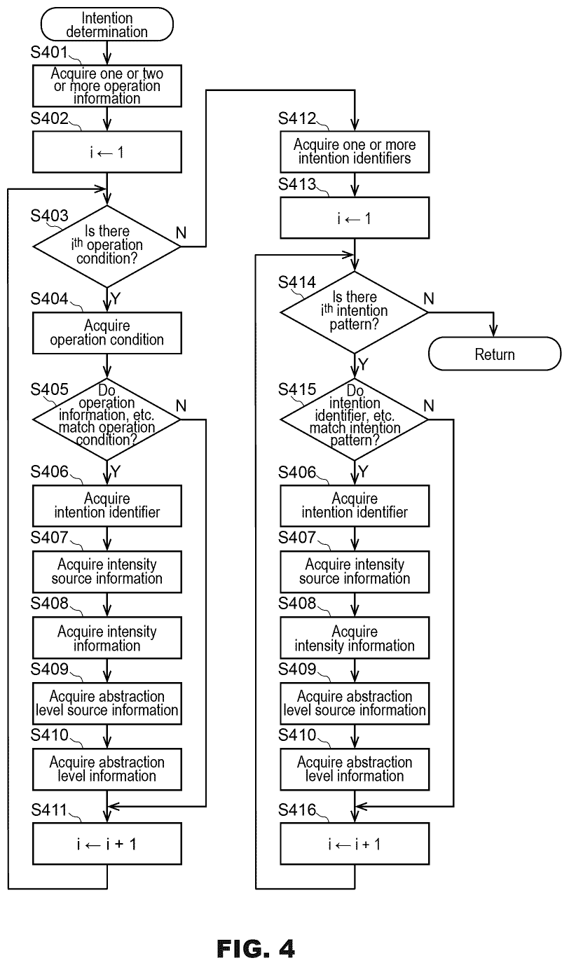

(Step S305) The determining unit 132 determines an intention identifier, using the operation information accumulated in step S304. The using the operation information accumulated in step S304 is using the operation information received in step S301. An example of intention determining processing, which is processing for determining an intention identifier, will be described later with reference to the flowchart in FIG. 4.

(Step S306) The intention accumulating unit 133 accumulates the intention identifier and the like determined in step S305, in the intention storage unit 114, in association with the user identifier acquired in step S302. The intention identifier and the like may be only the intention identifier, or information having one or more of the intensity information and the abstraction level information as well as the intention identifier. The intention identifier and the like preferably have time information corresponding to the time at which the intention was detected.

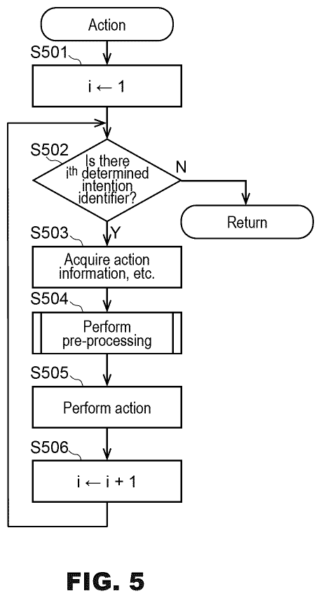

(Step S307) The action unit 135 and the like perform an action corresponding to the intention identifier determined in step S306. The procedure returns to step S301. An example of such an action will be described later with reference to the flowchart in FIG. 5.

(Step S308) The processing unit 13 determines whether or not it is time to perform an action. If it is time to perform an action, the procedure advances to step S309, or otherwise the procedure advances to step S313.

The time to perform an action is, for example, the case in which a predetermined time is reached, the case in which an instruction to perform an action is received from a terminal (not shown) of the administrator of the information processing apparatus 1, the case in which an instruction is received from a terminal (not shown) of the administrators of the web servers B, or the like, but there is no limitation on the time.

(Step S309) The processing unit 13 substitutes 1 for a counter i.

(Step S310) The determining unit 132 determines whether or not there is an i^{th} user identifier for which the action is to be performed. If there is such an i^{th} user identifier, the procedure advances to step S311, or otherwise the procedure returns to step S301.

The i^{th} user identifier is, for example, an i^{th} user identifier among the user identifiers stored in the user storage unit 111. The i^{th} user identifier is, for example, an i^{th} user identifier among the user identifiers specified with a received instruction. This instruction is an instruction to perform an action.

(Step S311) The determining unit 132 acquires the i^{th} user identifier. The procedure advances to step S305. In this example, after steps S305 to S307 are performed, the procedure advances to step S312.

(Step S312) The processing unit 13 increments the counter i by 1. The procedure returns to step S310.

(Step S313) The receiving unit 12 determines whether or not it has received information. If it has received information, the procedure advances to step S314, or otherwise the procedure returns to step S301. The information is, for example, user information or correspondence information. For example, the receiving unit 12 receives user information from the terminal apparatuses 2. For example, the receiving unit 12 receives correspondence information from a terminal (not shown) of the administrator of the information processing apparatus 1 or the like.

(Step S314) The processing unit 13 accumulates the information received in step S313, in an appropriate storage area. The procedure returns to step S301. The processing unit 13 accumulates the user information received in step S313, in the user storage unit 111. The processing unit 13 accumulates the correspondence information received in step S313, in the correspondence storage unit 112.

In the flowchart in FIG. 3, the processing unit 13 preferably acquires one or more dynamic attribute values of a user using the received operation information, and accumulates them in the user storage unit 111.

In the flowchart in FIG. 3, the processing ends at power off or at an interruption of termination processing.

Next, an example of the intention determining processing in step S305 will be described with reference to the flowchart in FIG. 4.

(Step S401) The determining unit 132 acquires one or two or more pieces of operation information that are each paired with a user identifier, from the operation storage unit 113. The one or more pieces of operation information in this example may be only operation information received immediately before, but preferably include past operation information. The past operation information is, for example, operation information received in a session that is different from a session corresponding to the operation information received immediately before. The different sessions may be different times, different days, or the like.

(Step S402) The determining unit 132 substitutes 1 for a counter i.

(Step S403) The determining unit 132 determines whether or not there is an i^{th} operation condition that is to be evaluated, in the correspondence storage unit 112. If there is such an i^{th} operation condition, the procedure advances to step S404, or otherwise the procedure advances to step S411. The i^{th} operation condition that is to be evaluated is, for example, an i^{th} operation condition of all operation conditions in the correspondence storage unit 112. The i^{th} operation condition that is to be evaluated is, for example, an i^{th} operation condition corresponding to the target website (webpage).

(Step S404) The determining unit 132 acquires the i^{th} operation condition that is to be evaluated, from the correspondence storage unit 112.

(Step S405) The determining unit 132 analyzes the one or more pieces of operation information acquired in step S401, thereby determining whether or not there is any operation information that matches the ith operation condition acquired in step S404. If there is any operation information that matches the i^{th} operation condition, the procedure advances to step S406, or otherwise the procedure advances to step S411.

(Step S406) The information acquiring unit 134 acquires an intention identifier corresponding to the i^{th} operation condition, from the correspondence storage unit 112.

(Step S407) The information acquiring unit 134 acquires intensity source information from the one or more pieces of operation information acquired in step S401. In this example, there may be a case in which the intensity source information cannot be acquired.

(Step S408) The information acquiring unit 134 acquires intensity information corresponding to the intensity source information acquired in step S407. In this example, there may be a case in which the intensity information cannot be acquired.

(Step S409) The information acquiring unit 134 acquires abstraction level source information from the one or more pieces of operation information acquired in step S401. In this example, there may be a case in which the abstraction level source information cannot be acquired.

(Step S410) The information acquiring unit 134 acquires abstraction level information corresponding to the abstraction level source information acquired in step S409. In this example, there may be a case in which the abstraction level information cannot be acquired.

(Step S411) The determining unit 132 increments the counter i by 1. The procedure returns to step S403.

(Step S412) The determining unit 132 acquires an intention identifier and the like that are paired with the user identifier, from the intention storage unit 114. The determining unit 132 acquires the intention identifier and the like acquired in steps S406 to S410. In this example, the intention identifier and the like may be only the intention identifier, or information having one or more of the intensity information and the abstraction level information as well as the intention identifier.

(Step S413) The determining unit 132 substitutes 1 for a counter i.

(Step S414) The determining unit 132 determines whether or not there is an i^{th} intention pattern using the intention identifier, the intention pattern being an i^{th} intention pattern that is to be evaluated. If there is such an i^{th} intention pattern, the procedure advances to step S415, or otherwise, the procedure returns to the upper-level processing.

(Step S415) The determining unit 132 acquires the i^{th} intention pattern that is to be evaluated. Next, the determining unit 132 determines whether or not the intention identifier and the like acquired in step S412 match the i^{th} intention pattern. If the intention identifier and the like match the i^{th} intention pattern, the procedure advances to step S406, or otherwise the procedure advances to step S416. In this example, in the case of advancing to step S406, the procedure advances to step S416 after steps S406 to S410 are performed.

(Step S416) The determining unit 132 increments the counter i by 1. The procedure returns to step S414.

Next, an example of the action in step S307 will be described with reference to the flowchart in FIG. 5.

(Step S501) The action unit 135 substitutes 1 for a counter i.

(Step S502) The action unit 135 determines whether or not there is an i^{th} determined intention identifier. If there is an i^{th} determined intention identifier, the procedure advances to step S503, or otherwise the procedure returns to the upper-level processing.

(Step S503) The action unit 135 acquires action information that is paired with the i^{th} determined intention identifier, from the correspondence storage unit 112.

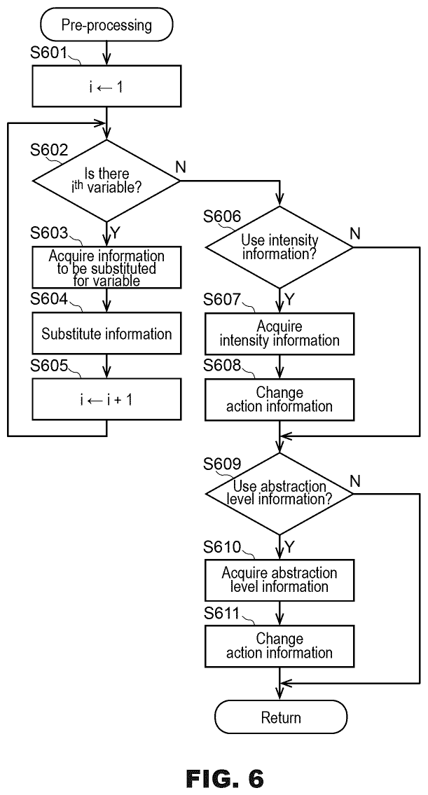

(Step S504) The action unit 135 performs pre-processing. An example of such pre-processing will be described later with reference to the flowchart in FIG. 6. There may be a case in which the pre-processing is not performed.

(Step S505) The action unit 135 performs an action using the action information acquired in in step S503 or the action information changed through the pre-processing in step S504.

(Step S506) The action unit 135 increments the counter i by 1. The procedure returns to step S502.

In the flowchart in FIG. 5, it is also possible that one or more of the intensity information, the abstraction level information, and the user attribute value are acquired before step S503, and action information that is paired with the above-mentioned one or more types of information and the ith determined intention identifier is acquired.

Next, an example of the pre-processing in step S504 will be described with reference to the flowchart in FIG. 6.

(Step S601) The action unit 135 substitutes 1 for a counter i.

(Step S602) The action unit 135 determines whether or not there is an i^{th} variable in the acquired action information. If there is an i^{th} variable, the procedure advances to step S603, or otherwise the procedure advances to step S606.

(Step S603) The action unit 135 acquires information that is to be substituted for the i^{th} variable. The action unit 135 typically acquires information that is to be substituted for the i^{th} variable, using operation information from which the determined intention identifier was acquired.

(Step S604) The action unit 135 substitutes the information acquired in step S603 for the i^{th} variable in the acquired action information.

(Step S605) The action unit 135 increments the counter i by 1. The procedure returns to step S602.

(Step S606) The action unit 135 determines whether or not to change the action information using intensity information. If the action information is to be changed, the procedure advances to step S607, or otherwise the procedure advances to step S609. Whether or not to change the action information using intensity information is typically determined in advance for each piece of action information or for each intention identifier.

(Step S607) The action unit 135 acquires intensity information that is paired with the focused intention identifier.

(Step S608) The action unit 135 changes the action information so as to match the intensity information acquired in step S607. In this example, there may be a case in which the action unit 135 does not have to change the action information as in the case in which the intensity information is a default value.

(Step S609) The action unit 135 determines whether or not to change the action information using abstraction level information. If the action information is to be changed, the procedure advances to step S607, or otherwise the procedure advances to step S609. Whether or not to change the action information using abstraction level information is typically determined in advance for each piece of action information or for each intention identifier.

(Step S610) The action unit 135 acquires abstraction level information that is paired with the focused intention identifier.

(Step S611) The action unit 135 changes the action information so as to match the abstraction level information acquired in step S610. In this example, there may be a case in which the action unit 135 does not have to change the action information as in the case in which the abstraction level information is a default value.

In the flowchart in FIG. 6, the action unit 135 used the intensity information and the abstraction level information to change the action information. However, the action unit 135 or the information acquiring unit 134 may acquire action information corresponding to the intention identifier, and one or more of the intensity information, the abstraction level information, and the user attribute value.

Next, an operation example of the terminal apparatus 2 will be described. The terminal accepting unit 22 of the terminal apparatus 2 accepts input of an instruction, information, or the like. Next, the terminal processing unit 23 changes the instruction, information, or the like accepted by the terminal accepting unit 22 into an instruction, information, or the like with a structure for sending. The terminal sending unit 24 sends the instruction, information, or the like to a web server B corresponding to the instruction or the like (e.g., the web server B corresponding to the URL contained in the instruction). The terminal receiving unit 25 receives information on a webpage or the like from the web server B that sent the instruction or the like. Next, the terminal processing unit 23 changes the information received by the terminal receiving unit 25 into information with a structure for output. Next, the terminal output unit 26 acquires the information (e.g., a webpage).

Furthermore, for example, the terminal processing unit 23 of the terminal apparatus 2 may configure operation information based on the operation accepted by the terminal accepting unit 22. The terminal sending unit 24 may send the operation information acquired by the terminal processing unit 23, to the information processing apparatus 1. In response to the sending of the operation information, for example, the terminal receiving unit 25 receives various types of information from the information processing apparatus 1. The various types of information are, for example, information according to an intention identifier determined by the information processing apparatus 1 in response to the sending of the operation information.

Moreover, in addition to the well-known web server functions, the web server B may send the operation information received from the terminal apparatus 2, in a pair with the user identifier corresponding to the terminal apparatus 2, to the information processing apparatus 1. In addition to the well-known web server functions, the web server B may process the operation information received from the terminal apparatus 2, and send the thus acquired operation information, in a pair with the user identifier corresponding to the terminal apparatus 2, to the information processing apparatus 1. The operation information received from the terminal apparatus 2 is, for example, information on a primitive operation (e.g., rightButtonON (ButtonID)), and the operation information acquired by processing the operation information is information with which a person can determine the meaning or implication of the operation (e.g., “Page OO is displayed”).

Hereinafter, a specific operation example of the information system A in this embodiment will be described. In the information system A, it is assumed that one or two or more web server B that are accessed by the terminal apparatus 2 are servers of e-commerce sites.

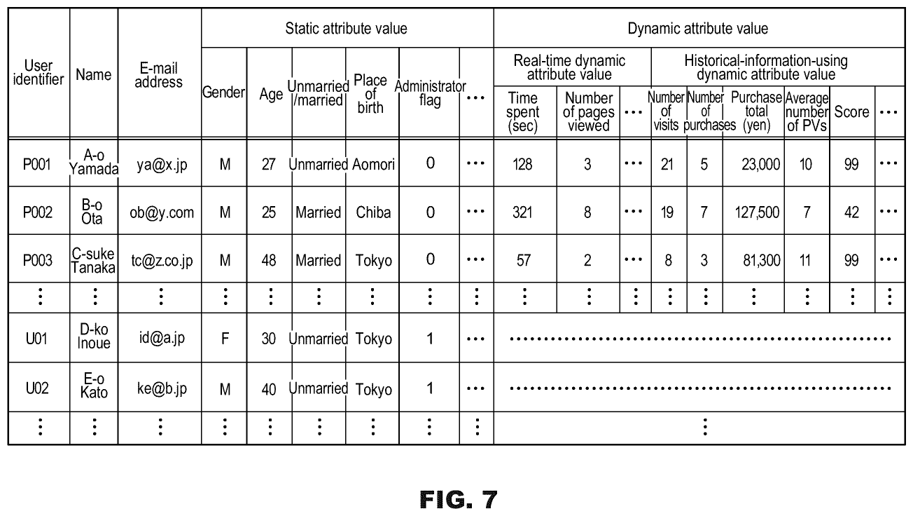

Furthermore, a user information management table shown in FIG. 7 is stored in the user storage unit 111 of the information processing apparatus 1. Records each having “user identifier”, “name”, “e-mail address”, “static attribute value”, and “dynamic attribute value” are stored in the user information management table.

“Static attribute value” is information received from the terminal apparatuses 2 or the web servers B and accumulated by the information processing apparatus 1. “Static attribute value” in this example has “gender”, “age”, “unmarried/married”, “place of birth”, “administrator flag”, and the like. “Unmarried/married” is information indicating whether the user is unmarried or married. “Administrator flag” is information indicating whether or not the user of the information processing apparatus 1 is an administrator. In this example, a user corresponding to the value “1” of the administrator flag is an administrator, and a user corresponding to the value “0” of the administrator flag is not an administrator.

“Dynamic attribute value” is information acquired by the processing unit 13 through analysis of the operation information in the operation storage unit 113 or the received operation information. “Dynamic attribute value” in this example has “real-time dynamic attribute value” and “historical-information-using dynamic attribute value”. “Real-time dynamic attribute value” in this example has “time spent” and “number of pages viewed”. “Time spent” is the time spent on the site during the current visit. “Number of pages viewed” is the number of pages viewed on the site during the current visit. “Historical-information-using dynamic attribute value” in this example has “number of visits”, “number of purchases”, “purchase total”, “average number of PVs”, “score”, and the like. “Number of visits” is the number of times the user visited this e-commerce site (e.g., the site including the pages identified with URL 1 and URL 2) so far. “Number of purchases” is the number of times the user purchased items on the e-commerce site so far. “Purchase total” is the total amount of money the user spent on items on the e-commerce site so far. “Average number of PVs” is an average number of pages viewed per visit of the user. “Score” is a score of the user. In this example, it is assumed that an operation expression for calculating a score using an increasing function whose parameters are attribute values of one or more of “number of visits”, “number of purchases”, “purchase total”, and “average number of PVs” is stored in the storage unit 11. Then, the processing unit 13 acquires attribute values of one or more of “number of visits”, “number of purchases”, “purchase total”, and “average number of PVs” of each user, and substitutes the one or more attribute values for the increasing function, thereby calculating a score of the user. This operation expression is preferably an operation expression for calculating a score using one or more pieces of information of the static attribute values. The operation expression may be, for example, an operation expression for performing calculation so as to increase the score value for a member “1”. For example, the operation expression preferably multiplies the score value by 1.1 for a member “1”, and does not change the score value for a member “0”. The technique by which the processing unit 13 analyzes the operation information and acquires a dynamic attribute value is a well-known technique, and thus a detailed description thereof has been omitted.

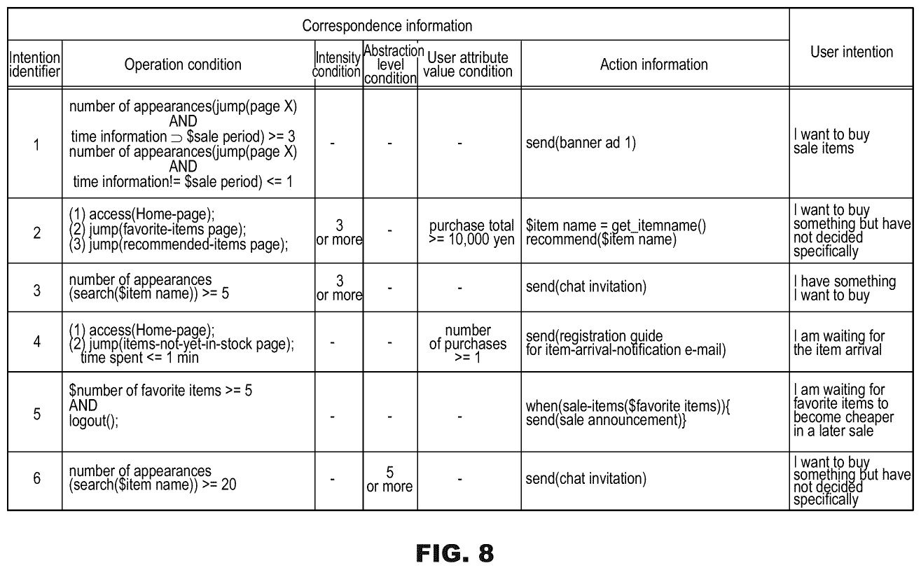

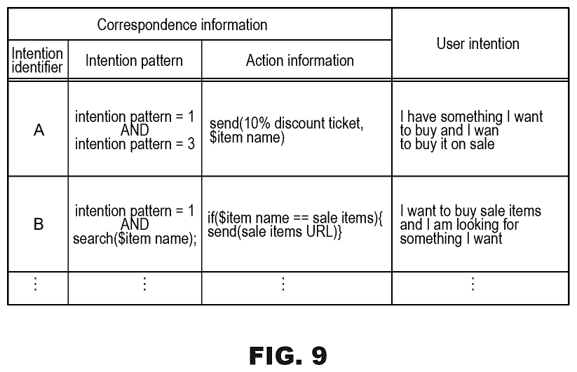

Furthermore, a first correspondence information management table shown in FIG. 8 and a second correspondence information management table shown in FIG. 9 are stored in the correspondence storage unit 112.

The first correspondence information management table is a table for managing one or more records each having “correspondence information” and “user intention”. “Correspondence information” in this case has “intention identifier”, “operation condition”, “intensity condition”, “abstraction level condition”, “user attribute value condition”, and “action information”. “Operation condition” is a condition regarding one or two or more pieces of operation information. “Operation condition” may also be said to be a condition of a pattern regarding one or two or more pieces of operation information, and thus it may also be said to be “operation pattern”. “Intensity condition” is a condition regarding intensity information. “Abstraction level condition” is a condition regarding abstraction level information. “User attribute value condition” is a condition regarding one or two or more user attribute values. “Correspondence information” always has attribute values of “operation pattern” and “action information”, but “intensity condition”, “abstraction level condition”, and “user attribute value condition” may be “NULL”. That is to say, the action information may be determined only from the operation condition, or may be determined based on one or two or more of the intensity condition, the abstraction level condition, and the user attribute value condition, in addition to the operation condition. “User intention” is information describing an intention of the user in the case in which a record in the first correspondence information management table is matched, and is information describing the meaning of this record.

“Operation condition” of the record with “ID=1” in the first correspondence information management table is that in operation information corresponding to one user identifier, “the number of times the user has visited page X during a sale period is 3 or more and the number of times the user has visited page X outside of a sale period is 1 or less”. It is assumed that values (e.g., 2022 Mar. 1 to 2022 Mar. 31, 2021 Dec. 1 to 2021 Dec. 31) corresponding to the variable “$sale period” are stored in the storage unit 11 in association with the page identifier “page X”. Furthermore, “time information⊃$sale period” indicates that “the time information corresponding to the operation information (in this case, jump (page X)) is included in a sale period”. “Time information!=$sale period” indicates that “the time information corresponding to the operation information (in this case, jump (page X)) is not included in any sale periods”. The action information “send (banner ad 1)” of the record with “ID=1” in the first correspondence information management table is a function of the action to send the banner ad “banner ad 1” to the terminal apparatus 2. It is assumed that “banner ad 1” is a banner that allows access to sale items. That is to say, the record with “ID=1” is a record that realizes sending a banner that allows access to sale items, to a terminal apparatus 2 of a user who has the intention “I want to buy sale items”.

“Operation condition” of the record with “ID=2” in the first correspondence information management table indicates that in the operation information in one session in the operation information corresponding to one user identifier, “the operation information (1), (2), and (3) appear in turn”. Other operation information may be interposed between the operation information (1), (2), and (3). The intensity condition “3 or more” of “ID=2” indicates that the intensity information is 3 or more.

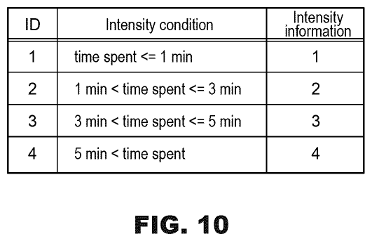

The intensity information is determined by referring to an intensity management table in FIG. 10. The intensity management table has two or more records each having “ID”, “intensity condition”, and “intensity information”. “ID” is information for identifying a record. “Intensity condition” is a condition for determining intensity information. For example, the intensity condition “1 min<time spent<=3 min” is a condition that the time spent on a focused page is “longer than 1 minute and 3 minutes or shorter”. “Intensity information” is intensity information that is acquired in the case in which the intensity condition that is paired therewith is satisfied. The focused page is the last page jumped to in the operation condition (e.g., “recommended-items page” in the record with “ID=2”). The intensity source information in this case is the time spent.

“User attribute value condition” of the record with “ID=2” in the first correspondence information management table is that the dynamic attribute value “purchase total” of the user is 10,000 yen or more. Furthermore, “$item name=get_itemname( )” constituting the action information of the record with “ID=2” in the first correspondence information management table is a function for acquiring one or more item names displayed on the focused page. “Recommend ($item name)” constituting the action information is a function for acquiring information on items related to the acquired one or more item names from the storage unit 11 or a recording medium (not shown), and sending the information to the terminal apparatus 2 (performing recommendation). That is to say, the record with “ID=2” is a record that realizes recommending, to a user who has the intention “I want to buy something but have not decided specifically” and whose purchase total up to now is 10,000 yen or more, items related to the items that the user is viewing.

“Operation condition” of the record with “ID=3” in the first correspondence information management table indicates that in operation information in a specific period corresponding to one user identifier, operation information that matches “search ($item name)” appears five times or more (an item was searched for five times or more). The intensity condition “3 or more” of this record in this case indicates that a search using the same item name was performed three times or more. That is to say, it is assumed that the intensity information in this case is acquired as “intensity information=largest number of searches performed using same item name”. The action information “send (chat invitation)” of this record indicates that a chat invitation to the effect that “details can be checked with a clerk” is sent to the terminal apparatus 2. That is to say, the record with “ID=3” is a record that realizes sending the above-mentioned chat invitation to a terminal apparatus 2 in the case in which the user has the intention “I have something I want to buy” and the intension corresponds to an intensity condition of 3 or more. Such a chat invitation is stored in the storage unit 11.

“Operation condition” of the record with “ID=4” in the first correspondence information management table indicates that the operation information appears in the order of (1) and (2) and the time spent on the page in (2) (items-not-yet-in-stock page) is 1 minute or shorter. That is to say, the operation condition may be a condition including one or more dynamic attribute values of a user (e.g., a real-time dynamic attribute value, and in this case, time spent). The action information “send (registration guide for item-arrival-notification e-mail)” of this record is a function for sending a registration guide for an e-mail to make a notification regarding the item arrival, to the terminal apparatus 2. That is to say, the record with “ID=4” is a record that realizes sending a registration guide for an e-mail to make a notification regarding the item arrival, to a terminal apparatus 2 of a user who has the intention “I am waiting for the item arrival” and whose number of purchases is 1 or more. Such a registration guide for an e-mail to make a notification regarding the item arrival is stored in the storage unit 11.

“Operation condition” of the record with “ID=5” in the first correspondence information management table indicates that in a state in which the variable “$number of favorite items” corresponding to one user identifier is 5 or more, a logout operation was performed without purchasing or removing any items in the buffer “favorite items”. The action information of this record indicates processing for sending a sale announcement to the terminal apparatus 2 in the case in which an item name in the variable “$favorite items” becomes corresponding to sale items. “Sale_items ($favorite items)” is a function for returning a value indicating whether or not an item corresponding to the item name in the variable “$favorite items” is on sale. “Send (sale announcement)” is a function for sending a sale announcement to the terminal apparatus 2. That is to say, the record with “ID=5” is a record that realizes sending a sale announcement to a terminal apparatus 2 of a user who has the intention “I am waiting for favorite items to become cheaper in a later sale” in the case in which the favorite items go on sale. Such a sale announcement is stored in the storage unit 11.

The record with “ID=6” in the first correspondence information management table is a record that realizes sending a chat invitation to a terminal apparatus 2 in the case in which in operation information in a specific period corresponding to one user identifier, the operation information that matches “search ($item name)” appears 20 times or more and the abstraction level condition that the abstraction level information is 5 or more is satisfied.

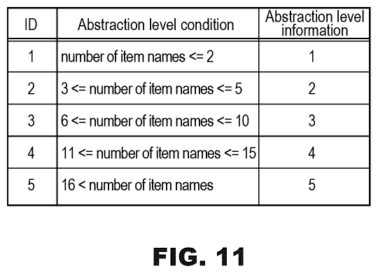

The abstraction level information is determined by referring to an abstraction level management table in FIG. 11. The abstraction level management table has two or more records each having “ID”, “abstraction level condition”, and “abstraction level information”. The abstraction level condition “3<=number of item names<=5” indicates that the number of item names searched for is 3 or more and 5 or less. That is to say, it is indicated that the larger number of types of items a user is searching for, the less specific (the more abstract) what he/she wants is.

The second correspondence information management table (FIG. 9) is a table for managing one or more records each having “correspondence information” and “user intention”. “Correspondence information” in this case has “intention identifier”, “intention pattern”, and “action information”. “Intention pattern” is a condition having one or more intention identifiers. “Intention pattern” may be a condition constituted by only two or more intention identifiers, or a condition using one or more intention identifiers and one or more pieces of operation information.

The action information with “ID=1” in FIG. 9 indicates that a 10% discount ticket is sent to a terminal apparatus 2 of a user that matches both the intention identifiers “1” and “3”. That is to say, the record with “ID=1” in FIG. 9 is a record that realizes sending a 10% discount ticket to a terminal apparatus 2 of a user who has the intention “I have something I want to buy and I want to buy it on sale”.

The record with “ID=2” in FIG. 9 is a record that realizes sending, to a user who has the intention “I want to buy sale items” and who has searched for an item, a URL of a page of sale items (sale items URL) in the case in which the item searched for is on sale.

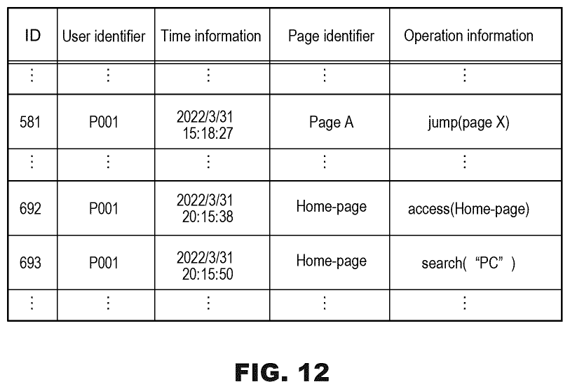

Furthermore, an operation information management table having the structure shown in FIG. 12 is stored in the operation storage unit 113. The operation information management table is a table for managing the operation information and the like accumulated by the operation accumulating unit 131. The operation information management table manages one or more records each having “ID”, “user identifier”, “time information”, “page identifier”, and “operation information”.

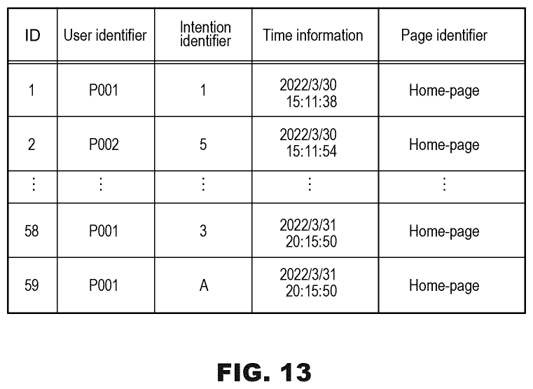

Moreover, a user intention management table having the structure shown in FIG. 13 is stored in the intention storage unit 114. The intention management table is a table for managing the intention identifier and the like accumulated by the intention accumulating unit 133, the intention identifier and the like corresponding to a user identifier. The user intention management table has one or more records each having “ID”, “user identifier”, “intention identifier”, “time information”, and “page identifier”.

In this situation, the information system A operates as follows. That is to say, a user (in this case, A-o Yamada) accesses one web server B using the terminal apparatus 2 to search for and view item information and purchase an item, for example.

The terminal apparatus 2 accepts input from the user, and sends one or more pieces of operation information to the web server B. The terminal apparatus 2 sends the one or more pieces of operation information to the information processing apparatus 1. The receiving unit 12 of the information processing apparatus 1

receives the one or more pieces of operation information in association with the user identifier “P001”. The operation accumulating unit 131 acquires the user identifier “P001” associated with the received operation information. Next, the operation accumulating unit 131 acquires time (time information (e.g., 2022 Mar. 31 20:15:38)) from a clock (not shown). The operation accumulating unit 131 acquires a page identifier associated with the received operation information (an identifier (e.g., “Home_page”) of a page on which the user performed an operation). The operation accumulating unit 131 acquires the received operation information (e.g., “access (home_page)”). Next, the operation accumulating unit 131 configures information that is to be accumulated. Next, the operation accumulating unit 131 accumulates the configured information in the operation information management table (see FIG. 12). This record is a record with “ID=692”.

Furthermore, the determining unit 132 tries to determine an intention identifier using the accumulate operation information. That is to say, the determining unit 132 tries to determine an intention identifier according to the flowchart in FIG. 4. However, in this example, it is assumed that the determining unit 132 cannot determine an intention identifier.

Next, it is assumed that the user enters “PC” in an item search field on the homepage identified with “home_page” and operates a search button. Then, the terminal apparatus 2 accepts this instruction, configures operation information “search (“PC”)”, and sends the information to one web server B. As a result, the terminal apparatus 2 receives the search results from the web server B and outputs the results.

Furthermore, the terminal apparatus 2 sends the operation information “search (“PC”)” to the information processing apparatus 1.

Next, the receiving unit 12 of the information processing apparatus 1 receives the operation information “search (“PC”)” in association with the user identifier “P001”. The operation accumulating unit 131 acquires the user identifier “P001” associated with the received operation information. Next, the operation accumulating unit 131 acquires time (time information (e.g., 2022 Mar. 31 20:15:50)) from a clock (not shown). The operation accumulating unit 131 acquires a page identifier (e.g., “Home_page”) associated with the received operation information. The operation accumulating unit 131 acquires the received operation information “search (“PC”)”. Next, the operation accumulating unit 131 configures information that is to be accumulated. Next, the operation accumulating unit 131 accumulates the configured information in the operation information management table (FIG. 12). This record is a record with “ID=693”.

Next, the determining unit 132 tries to determine an intention identifier using the accumulate operation information. That is to say, the determining unit 132 tries to determine an intention identifier according to the flowchart in FIG. 4. That is to say, the determining unit 132 acquires one or more pieces of operation information that are each paired with the user identifier “P001”, from the operation information management table.

The determining unit 132 determines whether or not the acquired one or more pieces of operation information match the records in the first correspondence information management table. It is assumed that the determining unit 132 determines that with the newly received operation information “search (“PC”)”, the operation condition “number of appearances (search ($item name))>=5” corresponding to “ID=3” becomes satisfied. It is assumed that the determining unit 132 determines that the intensity information is “intensity information=largest number of searches performed using same item name=3”, and thus the intensity condition “3 or more” becomes satisfied.

Next, the determining unit 132 acquires the intention identifier “1” that is paired with the user identifier “P001” from the user intention management table (FIG. 13). Accordingly, the determining unit 132 has acquired the intention identifiers “1” and “3” that are each paired with the user identifier “P001”.

Next, the determining unit 132 acquires the intention identifier “A” corresponding to the intention pattern that the intention identifiers “1” and “3” match, from the second correspondence information management table.

Next, the intention accumulating unit 133 acquires the time information “2022 Mar. 31 20:15:50” and the page identifier “Home_page”. Next, the intention accumulating unit 133 accumulates two records each having the time information and the page identifier, the records respectively having the newly acquired intention identifiers “3” and “A”, in the user intention management table in FIG. 13, in a pair with the user identifier “P001”. These records are record with “IDs=58 and 59”.

Next, the action unit 135 acquires the action information “send (chat invitation)” that is paired with the intention identifier “3”, from the first correspondence information management table in FIG. 8. Next, the action unit 135 executes the action information “send (chat invitation)”. That is to say, the action unit 135 reads a chat invitation from the storage unit 11, and sends the chat invitation to the terminal apparatus 2 that sent the operation information (the terminal apparatus 2 corresponding to the user identifier “P001”).

Furthermore, the action unit 135 acquires the action information “send (10% discount ticket, $item name)” that is paired with the intention identifier “A”, from the second correspondence information management table in FIG. 9. Next, the action unit 135 acquires the variable “$item name” in the acquired action information. Next, the action unit 135 acquire the item name “PC” that is to be substituted for the variable “$item name”, from the operation information “search (“PC”)”. Next, the action unit 135 substitutes the item name “PC” for the variable “$item name”, and configures the action information “send (10% discount ticket, PC)” that is to be executed. Next, the action unit 135 executes the action information “send (10% discount ticket, PC)”. That is to say, the action unit 135 configures information on a ticket for a 10% discount for PCs, and sends the information to the terminal apparatus 2 that sent the operation information (the terminal apparatus 2 corresponding to the user identifier “P001”).

Next, the terminal apparatus 2 corresponding to the user identifier “P001” receives and outputs the chat invitation. The terminal apparatus 2 receives and outputs the information on a ticket for a 10% discount for PCs.

Through the above-described processing, the information processing apparatus 1 can estimate an intention based on an operation performed by a user on the terminal apparatus 2, and provide the user with appropriate services corresponding to the intention.

As described above, according to this embodiment, the information processing apparatus 1 can estimate an intention of a user based on an operation performed by the user on a webpage, and perform an appropriate action corresponding to the intention.

Furthermore, according to this embodiment, the information processing apparatus 1 can estimate an intention of a user and intensity thereof based on an operation performed by the user on a webpage, and perform an appropriate action corresponding to the intention and the intensity.

Furthermore, according to this embodiment, the information processing apparatus 1 can estimate an intention of a user and an abstraction level thereof based on an operation performed by the user on a webpage, and perform an appropriate action corresponding to the intention and the abstraction level.

Furthermore, according to this embodiment, the information processing apparatus 1 can estimate an intention of a user based on an operation performed by the user on a webpage, and perform an appropriate action corresponding to the intention, using unique information acquired from the operation information.

Furthermore, according to this embodiment, the information processing apparatus 1 can estimate multiple intentions of a user based on an operation performed by the user on a webpage, and perform an appropriate action corresponding to the multiple intentions.

Furthermore, according to this embodiment, the information processing apparatus 1 can estimate an intention of a user based on a pattern of an operation performed by the user on a webpage, and perform an appropriate action corresponding to the intention. The processing in this embodiment may be realized by software.

The software may be distributed by software downloads or the like. The software may be distributed in a form where the software is stored in a recording medium such as a CD-ROM. The same applies to other embodiments in this specification. The software that realizes the information processing apparatus 1 in this embodiment is the following sort of program. Specifically, this program is a program for causing a computer capable of accessing a correspondence storage unit in which one or more pieces of correspondence information each indicating correspondence between an intention identifier based on one or more pieces of operation information and action information for specifying an action that is to be performed on a terminal apparatus of a user are stored, to function as: a receiving unit that receives one or two or more pieces of operation information associated with a user identifier; a determining unit that determines an intention identifier corresponding to the one or more pieces of operation information received by the receiving unit; an information acquiring unit that refers to the correspondence storage unit, thereby acquiring action information corresponding to the intention identifier determined by the determining unit; and an action unit that performs an action specified with the action information acquired by the information acquiring unit, on a terminal apparatus corresponding to the user identifier.

### Embodiment 2

This embodiment is different from Embodiment 1 in that machine learning algorithm is used to determine an intention identifier.

That is to say, in this embodiment, the information processing apparatus acquires an intention identifier using a model acquired using two or more pieces of training data each having one or more pieces of operation information.

A conceptual diagram of an information system B in this embodiment is the same as that in FIG. 1, except for the reference numeral of an information processing apparatus 3. The information processing apparatus 3 is an apparatus that performs an action on the terminal apparatuses 2 based on operation information. The information processing apparatus 3 is typically a so-called server. The information processing apparatus 3 is, for example, a cloud server, an ASP server, or the like, but there is no limitation on the type thereof. The information processing apparatus 3 may also serve as a web server.

The information processing apparatus 3 and the one or more terminal apparatuses 2 can communicate with each other via a network such as the Internet. It is also possible that the one or more terminal apparatuses 2 can communicate with one or more web servers (not shown) as well via a network such as the Internet. It is preferable that the information processing apparatus 3 can communicate with the web servers B via a network such as the Internet.

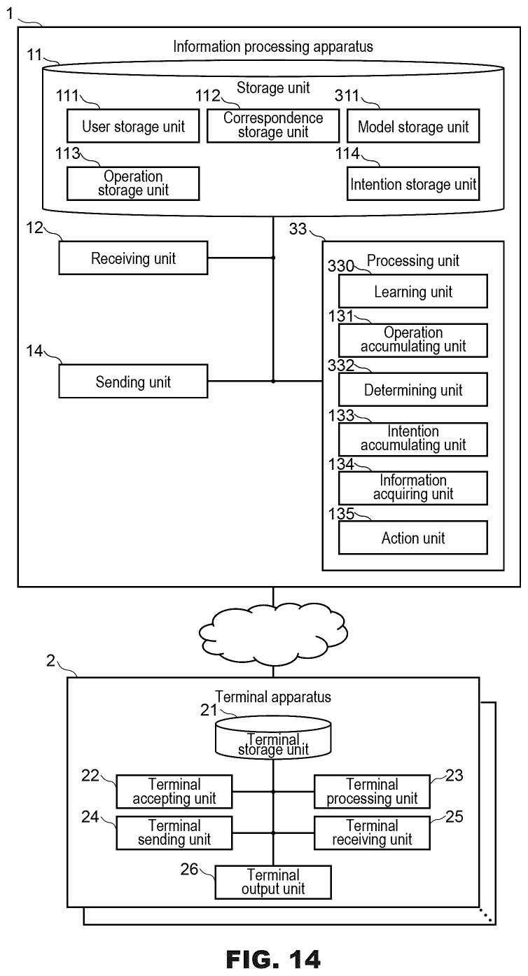

FIG. 14 is a block diagram of the information system B in this embodiment. The information system B includes the information processing apparatus 3 and one or two or more terminal apparatuses 2.

The information processing apparatus 3 includes a storage unit 31, the receiving unit 12, a processing unit 33, and the sending unit 14. The storage unit 31 includes the user storage unit 111, the correspondence storage unit 112, a model storage unit 311, the operation storage unit 113, and the intention storage unit 114. The processing unit 33 includes a learning unit 330, the operation accumulating unit 131, a determining unit 332, the intention accumulating unit 133, the information acquiring unit 134, and the action unit 135.

Various types of information are stored in the storage unit 31 constituting the information processing apparatus 3. The various types of information are, for example, two or more pieces of training data, a later-described model, user information, correspondence information, operation information, or an intention identifier.

The two or more pieces of training data are information for configuring a later-described model. The two or more pieces of training data for acquiring a multi-class classification model have one or more pieces of operation information serving as explanatory variables and an intention identifier serving as an objective variable. This training data preferably has a value of the objective variable to the effect that no intention identifier is matched. The two or more pieces of training data for acquiring binary classification model have, for each intention identifier, one or more pieces of operation information serving as a positive example and one or more pieces of operation information serving as a negative example.

One or two or more models are stored in the model storage unit 311. Each model may also be said to be a learner, a predictor, a learning model, a prediction model, or the like. The model is information configured through learning processing of machine learning using the two or more pieces of training data. The model is information that is used in prediction processing of machine learning in order to acquire an intention identifier. The model is information acquired through learning processing of machine learning using the two or more pieces of training data.

The model is, for example, information for predicting one intention identifier from two or more intention identifiers, using one or more pieces of operation information. The model in this case is a model for so-called multi-class classification. The model is, for example, information for predicting whether or not one intention identifier is matched, using one or more pieces of operation information. The model in this case is a model for so-called binary classification. If the model is a binary classification model, two or more models respectively associated with different intention identifiers are stored in the model storage unit 311.

Any machine learning algorithm can be used in this case, such as deep learning, random forest, decision tree, SVM, or the like. For machine learning, for example, various machine learning functions such as the TensorFlow library, the random forest module of the R language, fastText, TinySVM, and various other existing libraries can be used.

The processing unit 33 performs various types of processing. The various types of processing are, for example, processing that is performed by the learning unit 330, the operation accumulating unit 131, the determining unit 332, the intention accumulating unit 133, the information acquiring unit 134, and the action unit 135.

The learning unit 330 performs learning processing of machine learning using the two or more pieces of training data, thereby acquiring a model. The learning unit 330 accumulates the model in the model storage unit 311. If the information processing apparatus 3 does not perform learning processing, the learning unit 330 is not necessary.

For example, the learning unit 330 performs learning processing of machine learning using the two or more pieces of training data for multi-class classification, thereby acquiring a model for multi-class classification.

Furthermore, for example, the learning unit 330 performs, for each of the two or more intention identifiers, learning processing of machine learning using the two or more pieces of training data for binary classification corresponding to the intention identifiers, thereby acquiring a model for binary classification.

The determining unit 332 determines an intention identifier corresponding to the one or more pieces of operation information received by the receiving unit 12. The determining unit 332 performs prediction processing of machine learning using the one or more pieces of operation information received by the receiving unit 12 and the model in the storage unit 31, thereby determining an intention identifier.

For example, the determining unit 332 performs prediction processing of machine learning using the one or more pieces of operation information received by the receiving unit 12 and the model for multi-class classification, thereby determining an intention identifier.

For example, the determining unit 332 performs, for each of the two or more intention identifiers, prediction processing of machine learning using the one or more pieces of operation information received by the receiving unit 12 and models that are respectively paired with the intention identifiers, and determines whether or not the intention identifiers are matched. The determining unit 332 acquires an intention identifier corresponding to a model that is predicted to match. The determining unit 332 acquires a score through prediction processing of machine learning, and acquires an intention identifier corresponding to a model that has a prediction result indicating a match and that the score satisfies an acquisition condition. The acquisition condition is a condition for acquiring an intention identifier. The acquisition condition is, for example, that the score is greater than or equal to a threshold value or that the score is the highest value.

The storage unit 31, and the model storage unit 311 are preferably non-volatile recording media, but may alternately be realized by volatile recording media.

There is no limitation on the procedure in which information is stored in the storage unit 31 and the like. For example, information may be stored in the storage unit 31 and the like via a recording medium, information sent via a communication line or the like may be stored in the storage unit 31 and the like, or information input via an input device may be stored in the storage unit 31 and the like.

The receiving unit 12 and the terminal receiving unit 25 are typically realized by wireless or wired communication parts, but may also be realized by broadcast receiving parts.

The processing unit 33, the learning unit 330, and the determining unit 332 may be typically realized by processors, memories, or the like. Typically, the processing procedure of the processing unit 33 and the like is realized by software, and the software is stored in a recording medium such as a ROM. However, the processing procedure may be realized by hardware (dedicated circuits). The processors are, for example, CPUs, MPUs, GPUs, or the like, but there is no limitation on the type thereof.

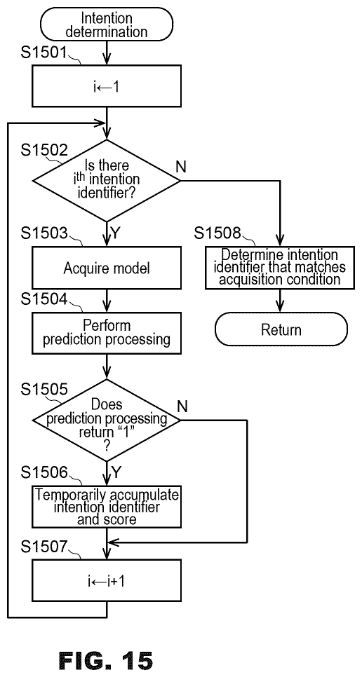

Next, an operation example of the information processing apparatus 3 constituting the information system B will be described. An operation example of the information processing apparatus 3 is different from the operation in the flowchart in FIG. 3, only in the intention determination operation in S305. Thus, an operation example of the intention determination in this case will be described with reference to the flowchart in FIG. 15. The flowchart in FIG. 15 shows the case in which two or more binary classification models are used.

(Step S1501) The determining unit 332 substitutes 1 for a counter i.

(Step S1502) The determining unit 332 determines whether or not there is an i^{th} intention identifier. If there is an i^{th} intention identifier, the procedure advances to step S1503, or otherwise the procedure advances to step S1508.

(Step S1503) The determining unit 332 acquires a model that is paired with the i^{th} intention identifier, from the model storage unit 311.

(Step S1504) The determining unit 332 performs prediction processing of machine learning using the model acquired in step S1503 and one or more pieces of operation information, thereby acquiring a prediction result. In this example, the determining unit 332 preferably further acquires a score. It is assumed that the prediction result is, for example, “1” in the case in which the intention identifier is matched, and is “0” in the case in which the intention identifier is not matched.

(Step S1505) If the prediction result acquired by the determining unit 332 in step S1504 is “1”, the procedure advances to step S1506, whereas the prediction result is “0”, the procedure advances to step S1507.

(Step S1506) The determining unit 332 temporarily accumulates the ith intention identifier and the score in a buffer (not shown). In this example, the determining unit 332 may accumulate only the i^{th} intention identifier.

(Step S1507) The determining unit 332 increments the counter i by 1. The procedure returns to step S1502.

(Step S1508) The determining unit 332 acquires an intention identifier that matches the acquisition condition, from the buffer (not shown). In this example, there may be a case in which the determining unit 332 cannot acquire an intention identifier. If there is no score in the buffer (not shown), in this example, the determining unit 332 acquires all intention identifiers in the buffer (not shown).

In the flowchart in FIG. 15, if a multi-class classification model is used, the determining unit 332 operates as follows. That is to say, the determining unit 332 performs prediction processing of machine learning using the one or more pieces of operation information and the model in the storage unit 31, thereby acquiring an intention identifier. In this example, the determining unit 332 may acquire information indicating that there is no intention of any kind.

As described above, according to this embodiment, it is possible to estimate an intention of a user based on an operation performed by the user on a webpage in accordance with an machine learning algorithm, and perform an appropriate action corresponding to the intention.

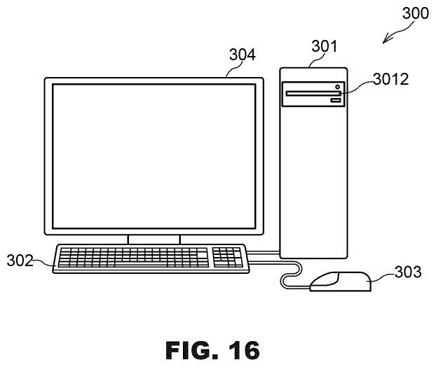

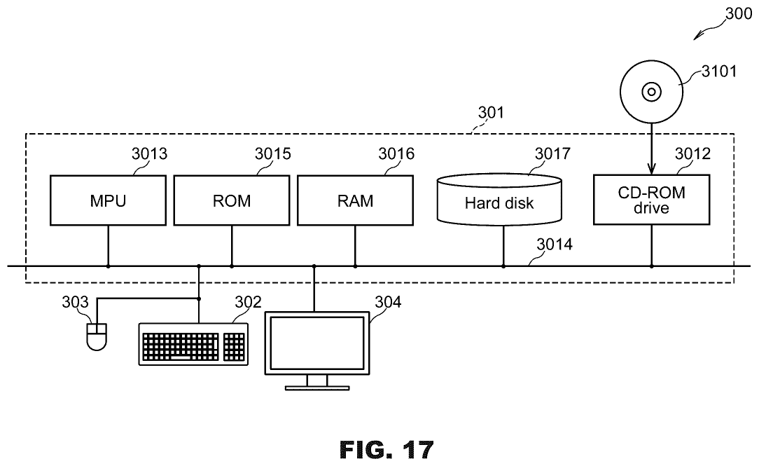

FIG. 16 shows the external appearance of a computer that executes the program described in this specification to realize the information processing apparatuses 1 and 3 and the like in various embodiments described above. The foregoing embodiments may be realized using computer hardware and a computer program executed thereon. FIG. 16 is a schematic view of a computer system 300. FIG. 17 is a block diagram of the system 300.

In FIG. 16, the computer system 300 includes a computer 301 including a CD-ROM drive, a keyboard 302, a mouse 303, and a monitor 304.

In FIG. 17, the computer 301 includes, in addition to the CD-ROM drive 3012, an MPU 3013, a bus 3014 connected to the CD-ROM drive 3012 and the like, a ROM 3015 in which a program such as a boot up program is stored, a RAM 3016 that is connected to the MPU 3013 and is a memory in which a command of an application program is temporarily stored and a temporary storage area is provided, and a hard disk 3017 in which programs such as an application program and a system program and data are stored. Although not shown, the computer 301 may further include a network card that provides connection to a LAN.

The program for causing the computer system 300 to execute the functions of the information processing apparatus 1 and the like in the foregoing embodiments may be stored in a CD-ROM 3101 that is inserted into the CD-ROM drive 3012, and be transmitted to the hard disk 3017. Alternatively, the program may be transmitted via a network (not shown) to the computer 301 and stored in the hard disk 3017. At the time of execution, the program is loaded into the RAM 3016. The program may be loaded from the CD-ROM 3101, or loaded directly from a network.

The program does not necessarily have to include, for example, an operating system (OS) or a third party program to cause the computer 301 to execute the functions of the information processing apparatus 1 and the like in the foregoing embodiments. The program may only include a command portion to call an appropriate function (module) in a controlled mode and obtain desired results. The manner in which the computer system 300 operates is well known, and thus a detailed description thereof has been omitted.

It should be noted that, in the program, in a step of transmitting information, a step of receiving information, or the like, processing that is performed only by hardware, for example, processing performed by a modem or an interface card in the transmitting step (processing that can be performed only by hardware) is not included.

Furthermore, the computer that executes the program may be constituted by a single computer, or constituted by multiple computers. That is to say, centralized processing may be performed, or distributed processing may be performed.

Furthermore, in the foregoing embodiments, it will be appreciated that at least two communication parts in one apparatus may be physically realized by one medium.

In the foregoing embodiments, each process may be realized as centralized processing using a single apparatus, or may be realized as distributed processing using multiple apparatuses.

The present invention is not limited to the embodiments set forth herein. Various modifications are possible within the scope of the present invention.

### INDUSTRIAL APPLICABILITY

As described above, the information processing apparatus according to the present invention has an effect that it is possible to estimate an intention of a user based on an operation performed by the user on a webpage, and perform an appropriate action corresponding to the intention, thus rendering this apparatus useful as a server apparatus for supporting e-commerce sites and the like.

1. An information processing apparatus comprising:
a correspondence storage unit in which one or more pieces of correspondence information each indicating correspondence between an intention identifier based on one or more pieces of operation information and action information for specifying an action that is to be performed on a terminal apparatus of a user are stored;
a receiving unit that receives one or two or more pieces of operation information associated with a user identifier;
a determining unit that determines an intention identifier corresponding to the one or more pieces of operation information received by the receiving unit;
an information acquiring unit that refers to the correspondence storage unit, thereby acquiring action information corresponding to the intention identifier determined by the determining unit; and
an action unit that performs an action specified with the action information acquired by the information acquiring unit, on a terminal apparatus corresponding to the user identifier.

2. The information processing apparatus according to claim 1,
wherein the correspondence information is information indicating correspondence between the intention identifier, an intensity condition regarding intensity information indicating intensity of an intention of a user, and the action information, and
the information acquiring unit acquires intensity information using the one or more pieces of operation information received by the receiving unit, and refers to the correspondence storage unit, thereby acquiring the action information corresponding to the intention identifier determined by the determining unit and an intensity condition that the intensity information matches.

3. The information processing apparatus according to claim 1,
wherein the correspondence information is information indicating correspondence between the intention identifier, an abstraction level condition regarding abstraction level information indicating an abstraction level of an intention of a user, and the action information, and
the information acquiring unit acquires abstraction level information using the one or more pieces of operation information received by the receiving unit, and refers to the correspondence storage unit, thereby acquiring the action information corresponding to the intention identifier determined by the determining unit and an abstraction level condition that the abstraction level information matches.

4. The information processing apparatus according to claim 1,
wherein the correspondence information is information indicating correspondence between the intention identifier, an attribute value condition regarding one or more user attribute values, and the action information, and
the information acquiring unit acquires a user attribute value, and refers to the correspondence storage unit, thereby acquiring the action information corresponding to the intention identifier determined by the determining unit and a user attribute value condition that the user attribute value matches.

5. The information processing apparatus according to claim 1,
wherein the information acquiring unit further acquires unique information in the one or more pieces of operation information, from the one or more pieces of operation information, and
the action unit performs an action using the action information and the unique information.

6. The information processing apparatus according to claim 1, further comprising:
an intention storage unit in which two or more intention identifiers are stored in association with a user identifier; and
an intention accumulating unit that accumulates the intention identifier determined by the determining unit, in the intention storage unit, in association with a user identifier,
wherein the information acquiring unit acquires the action information corresponding to two or more intention identifiers associated with one user identifier, the two or more intention identifiers having been accumulated by the intention accumulating unit.

7. The information processing apparatus according to claim 1,
wherein the intention identifier is associated with one or more operation conditions based on two or more pieces of operation information, and
the determining unit detects an operation condition that matches the one or more pieces of operation information, and determines the intention identifier corresponding to the operation condition.

8. The information processing apparatus according to claim 1, further comprising:
a model storage unit in which a model acquired through learning processing of machine learning using two or more pieces of training data each having one or more pieces of operation information and an intention identifier is stored,
wherein the determining unit performs prediction processing of machine learning using the one or more pieces of operation information and the model, and determines the intention identifier.

9. An information processing method realized using a correspondence storage unit in which one or more pieces of correspondence information each indicating correspondence between an intention identifier based on one or more pieces of operation information and action information for specifying an action that is to be performed on a terminal apparatus of a user are stored, a receiving unit, a determining unit, an information acquiring unit, and an action unit, comprising:
a receiving step of the receiving unit receiving one or two or more pieces of operation information associated with a user identifier;
a determining step of the determining unit determining an intention identifier corresponding to the one or more pieces of operation information received in the receiving step; and
an information acquiring step of the information acquiring unit referring to the correspondence storage unit, thereby acquiring action information corresponding to the intention identifier determined in the determining step; and
an action step of the action unit performing an action specified with the action information acquired in the information acquiring step, on a terminal apparatus corresponding to the user identifier.

10. A recording medium on which a program is recorded, the program causing a computer capable of accessing a correspondence storage unit in which one or more pieces of correspondence information each indicating correspondence between an intention identifier based on one or more pieces of operation information and action information for specifying an action that is to be performed on a terminal apparatus of a user are stored, to function as:
a receiving unit that receives one or two or more pieces of operation information associated with a user identifier;
a determining unit that determines an intention identifier corresponding to the one or more pieces of operation information received by the receiving unit;
an information acquiring unit that refers to the correspondence storage unit, thereby acquiring action information corresponding to the intention identifier determined by the determining unit; and
an action unit that performs an action specified with the action information acquired by the information acquiring unit, on a terminal apparatus corresponding to the user identifier.
